(19) United States
(12) Patent Application Publication
(10) Pub. No.: US 2003/0093906 A1
(43) Pub. Date: May 22, 2003

(54) Metal shears

(76) Inventor: Hsin-Te Huang, Taichung (TW)

Correspondence Address: Rabin & Berdo, P.C., 1101 14th Street, Suite 500, Washington, DC, 20005, US

(21) Appl. No.: 09/988,655

(22) Filed: Nov. 20, 2001

(51) Int. Cl. B26B 13/00

(52) U.S. Cl. 30/250

(57) ABSTRACT

A pair of metal shears has a main body, a moveable blade and a moveable handle. The main body has a fixed blade and a handle. A notch is defined in the main body near the rear end of the fixed blade. The moveable blade is pivotally attached to the main body with a first pivot pin. A cutting edge is formed on the moveable blade and faces a cutting edge on the fixed blade. The moveable handle is pivotally attached to the moveable blade with a second pivot pin. A key is formed on the moveable handle and operationally engages the notch in the main body. Accordingly, the blade on the main body will pivot and close the cutting edge on the moveable blade by means of the transmission of the key and the notch. The structure of the pair of the metal shears is simplified.

### BACKGROUND OF THE INVENTION

1. Field of the Invention

The present invention relates to a metal shears, and more particularly to metal shears with a simple structure and a locking device.

2. Description of Related Art

With reference to FIG. 5, a pair of conventional metal shears in accordance with the prior art comprises two blades (30, 32) and two handles (34, 36). The blades (30, 32) are pivotally connected to each other with a first pivot pin (not numbered). Each handle (34, 36) is pivotally attached to one of the blades (30, 32). The handles (34, 36) are pivotally connected to each other with a second pivot pin (not numbered). A spring (not shown) is mounted between the handles (34, 36) to provide a biasing force to push the handles (34, 36) apart. Accordingly, the blades (30, 32) will keep open by the biasing force of the spring. When the handles (34, 36) are squeezed together, the blades (30, 32) will close, such that the pair of metal shears can be used to cut a metal sheet or steel.

However, to reduce the force that must be applied by the user to cut a metal sheet or steel, four pivot pins are needed in the conventional metal shears to pivotally connect the blades (30, 32) and handles (34, 36). To assemble and to manufacture the conventional metal shears is complex. In addition, a user, especially a child, is easily cut by the blades (30, 32) when he or she holds or plays with the metal shears. Improvement in the operational safety of the conventional metal shears is needed.

To overcome the shortcomings, the present invention provides an improved pair of metal shears to mitigate or obviate the aforementioned problems.

### SUMMARY OF THE INVENTION

The main objective of the invention is to provide an improved pair of metal shears with only two pivot pins so as to simplify the structure of the metal shears. The pair of metal shears has a main body, a moveable blade and a moveable handle. The main body has a front end, a rear end, a fixed blade formed on the front end and a handle formed on the rear end. A notch is defined in the main body near the rear end of the fixed blade. The moveable blade is pivotally attached to the main body with a first pivot pin. A cutting edge is formed on the moveable blade and faces a cutting edge on the fixed blade. The moveable handle is pivotally attached to the rear end of the moveable blade with a second pivot pin. A key is formed on the moveable handle and operationally engages the notch in the main body. Accordingly, the blade on the main body will pivot to close the fixed blade on the moveable blade by means of the transmission of the key and the notch. The force provided by the user will be enlarged as the force applied to the main body. Because only two pivot pins are needed in the pair of metal shears, the structure of the pair of the metal shears is simplified. To assemble the pair of metal shears is more convenient.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a pair of metal shears in accordance with the present invention;

FIG. 2 is an exploded perspective view of the pair of metal shears in FIG. 1;

FIG. 3 is a side plan view of the pair of metal shears in FIG. 1;

FIG. 4 is an operational side plan view of the pair of metal shears in FIG. 1 with the blades closed; and

FIG. 5 is a perspective view of a conventional pair of metal shears in accordance with the prior art.

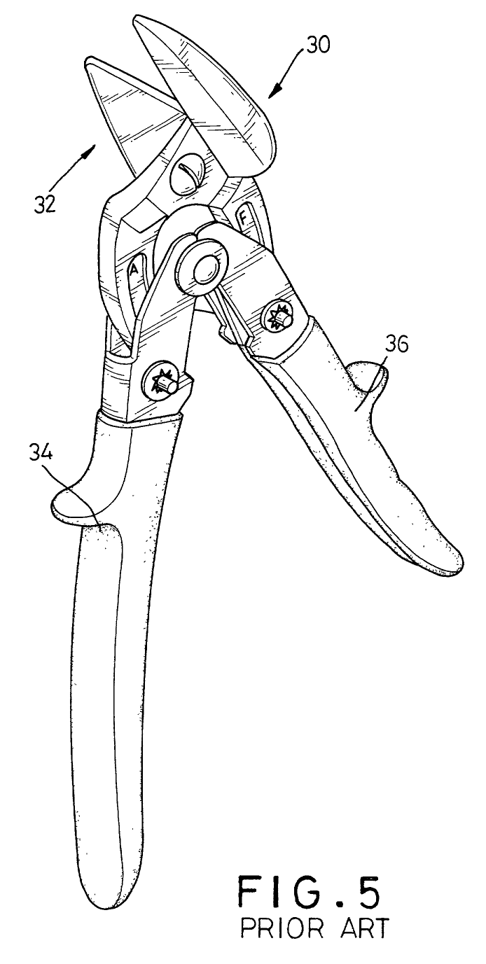

### DETAILED DESCRIPTION OF PREFERRED EMBODIMENT

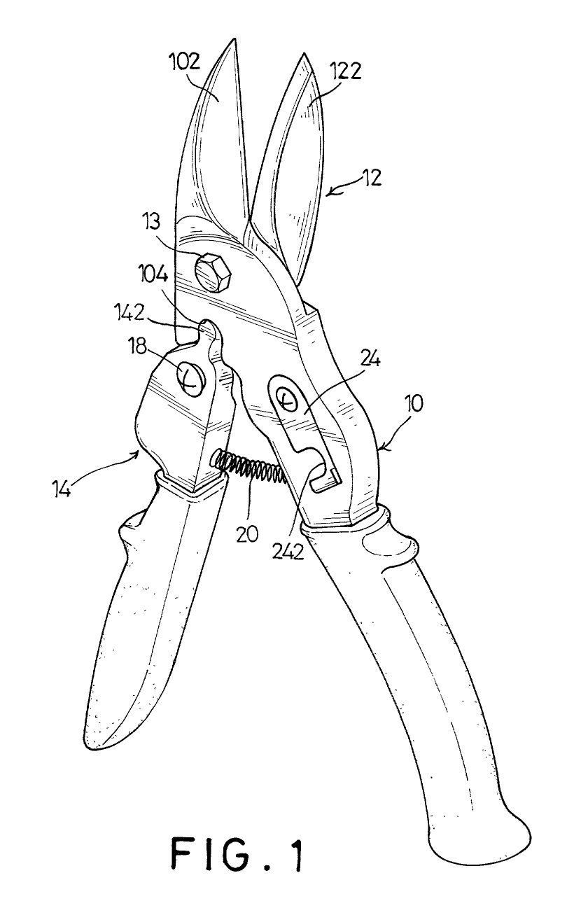

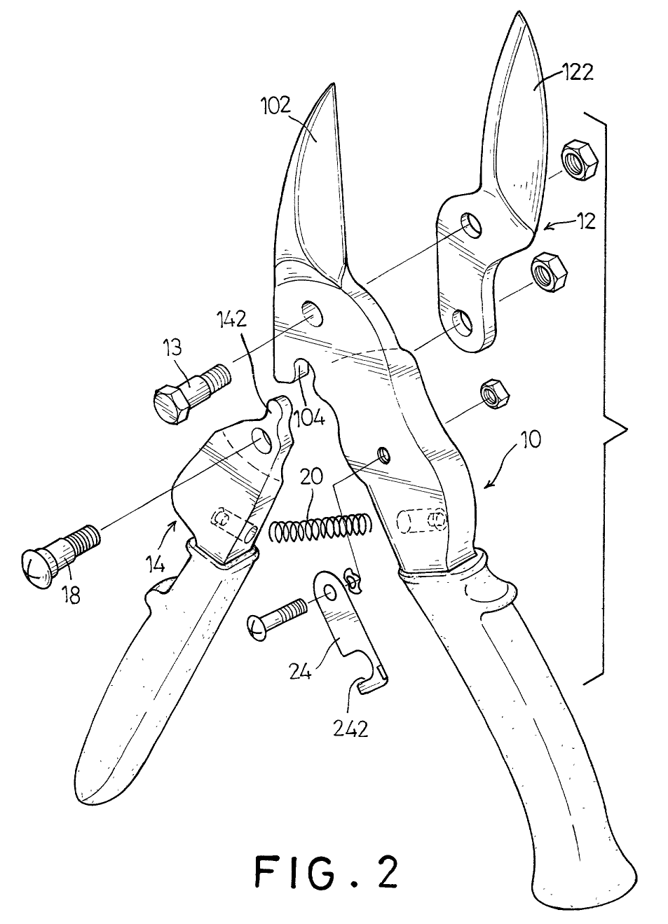

With reference to FIGS. 1 and 2, a pair of metal shears in accordance with the present invention comprises a main body (10), a moveable blade (12) and a moveable handle (14). The main body (10) has a front end (not numbered) and a rear end (not numbered). A fixed blade (102) with a fixed end (not numbered) and a free end (not numbered) is formed on the front end of the main body (10), and a handle (not numbered) is formed on the rear end. A notch (104) is defined in the main body (10) near the fixed end of the blade (102).

The moveable blade (12) has an interior cutting edge (122), an exterior edge, a front end and a rear end and is pivotally attached to the main body (10) with a first pivot pin (13). The cutting edge (122) on the moveable blade (12) faces and corresponds to a cutting edge (not numbered) on the fixed blade (102).

The moveable handle (14) is pivotally attached to the rear end of the moveable blade (12) with a second pivot pin (18), and a grip (not numbered) is formed on the moveable handle (14) at the end away from the moveable blade (12). A key (142) is formed on the moveable handle (14) near the second pivot pin (18) to selectively engage with the notch (104) in the main body (10).

A spring (20) is mounted between the main body (10) and the moveable handle (14) to provide a biasing force to push the main body (10) away from the moveable handle (14).

In addition, a locking lever (24) is pivotally attached to the main body (10). A locking notch (242) is defined in the locking lever (24) to engage the second pivot pin (18). Consequently, the main body (10) and the moveable handle (14) can be kept in a closed condition by means of the engagement between the second pivot pin (18) and the locking notch (242) in the locking lever (24). This can provide good safety to a person, even when he or she holds the metal shears in play.

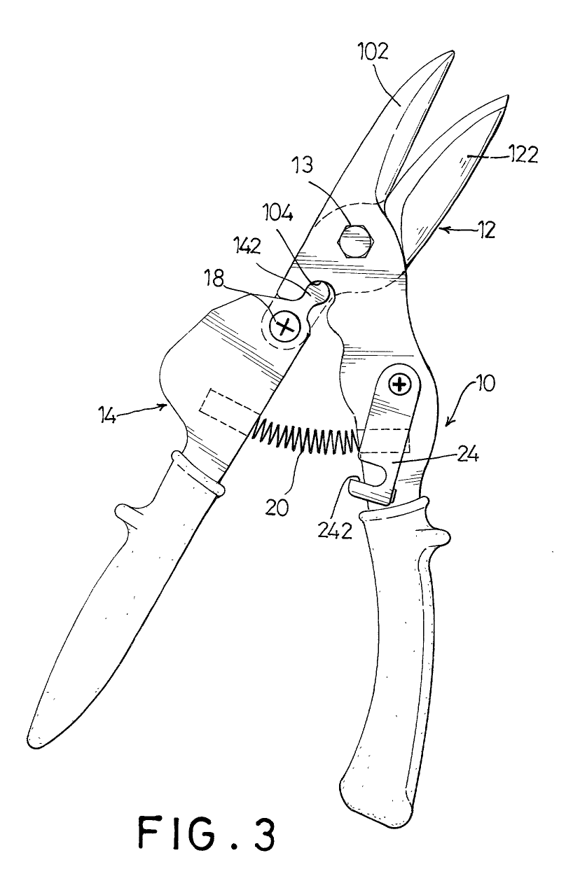

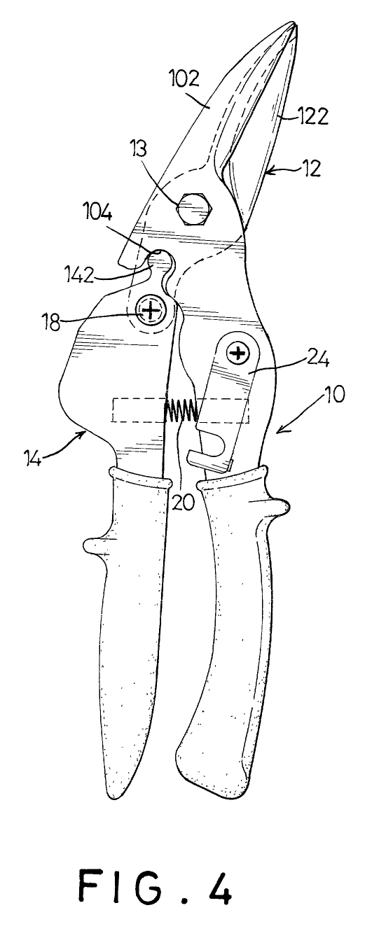

With reference to FIGS. 2, 3 and 4, the metal shears are operated by first releasing the locking lever (24) from the second pivot pin (18). When the handle on the main body (10) and the moveable handle (14) are squeezed together, the key (142) on the moveable handle (14) will push against the inner surface of the notch (104) in the main body (10). Accordingly, the fixed blade (102) on the main body (10) will pivot and close with the cutting edge (122) on the moveable blade (12) by means of the transmission of the key (142) and the notch (104). Because the key (142) is formed near the second pivot pin (18), the moment arm between the handle on the moveable handle (14) and the second pivot pin (18) is much larger than that between the key (142) and the second pivot pin (18). The force provided by the user will be enlarged as the force applied to the main body (10) through the key (142). Accordingly, the pair of metal shears can used to cut a metal sheet or steel.

When the user release the the handles, the main body (10) will be pushed away from the moveable handle (14) by means of the recoil force stored in the spring (20). If there is no spring (20) mounted between the main body (10) and the moveable handle (14), the user must separate the main body (10) and the moveable handle (14) by himself or herself. The blades (102, 122) will also rotate separately with each other. Because only two pivot pins (13, 18) are in the pair of metal shears, the structure of the pair of metal shears is simplified. To assemble the pair of metal shears is more convenient. The cost for manufacturing the pair of metal shears is reduced.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A pair of metal shears comprising:
a main body having a front end, a rear end, a fixed blade formed on the front end, a handle formed on the rear end and a notch defined in the main body near a rear end of the fixed blade;
a moveable blade pivotally attached to the main body with a first pivot pin and having a cutting edge formed on one edge of the moveable blade and facing a cutting edge on the fixed blade; and
a moveable handle pivotally attached to the rear end of the moveable blade with a second pivot pin and having a key formed on the moveable handle near the second pivot pin to operationally engage the notch in the main body,
whereby the cutting edge on the main body will pivot toward the cutting edge on the moveable blade by means of the transmission of the key and the notch when the handles on the main body and the moveable handle are squeezed together.

2. The pair of metal shears as claimed in claim 1 further comprising a spring mounted between the main body and the moveable handle to provide a biasing force to push the main body away from the moveable handle.

3. The pair of metal shears as claimed in claim 1 further comprising a locking lever pivotally attached to the main body and having a locking notch defined in the locking lever to engage with the second pivot pin to keep the main body and the moveable handle closed.
